(19) United States
(12) Patent Application Publication
(10) Pub. No.: US 2008/0111876 A1
(43) Pub. Date: May 15, 2008

(54) THERMAL PRINTER

(76) Inventors: Tsuneyuki Sasaki, Fukushima-ken (JP); Hirotoshi Terao, Fukushima-ken (JP)

Correspondence Address: BRINKS HOFER GILSON & LIONE, P.O. BOX 10395, CHICAGO, IL, 60610, US

(21) Appl. No.: 11/935,069

(22) Filed: Nov. 5, 2007

(30) Foreign Application Priority Data
Nov. 10, 2006 (JP) 2006-305386

(51) Int. Cl. B41J 2/335

(52) U.S. Cl. 347/197

(57) ABSTRACT

A thermal printer includes: a thermal head that has heating elements arranged on a head substrate in a longitudinal direction thereof. A head supporting member has a head supporting portion, which is a rectangular plate, for supporting the thermal head at a leading end, and pivots on a rotating axis that is provided at a rear end to contact or separate the thermal head with or from a platen. A plurality of rectangular opening portions are provided in a surface of the head supporting portion in the longitudinal direction so as to extend in a direction orthogonal to the longitudinal direction. In the thermal printer, the thermal head is directly fixed to the head supporting portion.

### CLAIM FOR PRIORITY

This application claims benefit of the Japanese Patent Application No. 2006-305386 filed on Nov. 10, 2006, which is hereby incorporated by reference.

### BACKGROUND OF THE INVENTION

1. Field of the Invention

The present invention relates to a thermal printer that makes heating elements of a thermal head selectively generate heat to record information, and more particularly, to the structure of a thermal printer that can reduce the amount of curvature of a thermal head during heating, due to the difference in physical properties between a member adhered to the thermal head and a member adhered to a head supporting member for supporting the thermal head, and reduce the thickness of the peripheral structure of the thermal head and the number of parts.

2. Description of the Related Art

In recent years, a thermal printer that selectively drives a plurality of heating elements provided in a thermal head to generate heat, on the basis of recording information, while transporting a recoding medium, thereby recording information on the recording medium, has been put to practical use (for example, see JP-A-2005-305994).

A thermal printer 1 according to the related art will be described with reference to FIGS. 5 and 6. FIG. 5 is a perspective view illustrating a printing unit of a thermal printer according to the related art, and FIG. 6 is a side view schematically illustrating main components of a thermal head.

A cylindrical platen roller 2 is rotatably supported by a side plate of a frame (not shown). In addition, a long thermal head 3 composed of a line head is provided above the platen roller 2 such that it can contact with or be separated from the platen roller 2 (head up/down).

The thermal head 3 has heating elements 3b that are arranged on a head substrate 3a formed of ceramic in the longitudinal direction, and is supported by a leading end of the head supporting member 4 such that the heating elements 3b can contact with or be separated from the platen roller 2.

Specifically, the head supporting member 4 includes a first head supporting member 7 having a head supporting portion 5, which is a long rectangular plate member, and a pair of first arms 6 that are opposite to each other in a substantially U shape, and a second head supporting member 10 having an urging portion 8 and a pair of second arms 9 that are opposite to each other in a substantially U shape. The first arms 6 are opposite to the second arms 9, and the first head supporting member 7 and the second head supporting member 10 are formed in substantially U shapes in plan view.

The first head supporting member 7 is formed of a material having good heat dissipating properties, such as aluminum, and the head supporting portion 5 for supporting the thermal head 3 is formed at the leading ends of the pair of first arms 6 so that the head supporting portion 5 is integrated with the first arms 6.

The head supporting portion 5 also serves as a heat dissipating plate 11a of a heat dissipating member 11, and the rear end of the head supporting portion 5 is connected to a planar heat dissipating portion 11b that extends backward, thereby forming the heat dissipating member 11. The head substrate 3a of the thermal head 3 is attached to a lower surface of the head supporting portion 5 of the first head supporting member 7 with a head holder 12 interposed therebetween. Therefore, heat generated from the thermal head 3 during printing is dissipated from the planar heat dissipating portion 11b through the head supporting portion 5 serving as the heat dissipating plate 11a.

In the first head supporting member 7, an adjusting screw 13 capable of adjusting the amount of curvature of the thermal head 3 is provided at the center of the long rectangular head supporting portion 5 in the longitudinal direction.

When the adjusting screw 13 is tightened, the center of the thermal head 3 in the longitudinal direction is swollen from both ends in the downward of FIG. 5, so that the thermal head 3 is curved. When the adjusting screw 13 is loosened, the amount of curvature of the thermal head 3 is reduced. The tightening strength of the adjusting screw 13 to adjust the amount of curvature of the thermal head 3 is set to a predetermined value when a printer is assembled.

The pair of first arms 6 are arranged so as to extend backward from both ends of the head supporting portion 5 in the longitudinal direction, and a first support hole 6a, serving as a rotatable supporting portion, is formed at the rear end of each of the first arms 6. In addition, each of the first arms 6 has an anchoring portion 6b that is formed by cutting and bending outward an upper part of the outer circumferential side in the vicinity of the leading end where the head supporting portion 5 is arranged, and the anchoring portions 6b engage with urging members (not shown) that are provided in the frame.

The head supporting member 4 is formed by mounting the second head supporting member 10 having the urging portion 8 provided therein to an upper side of the head supporting portion 5 of the first head supporting member 7 having the above-mentioned structure.

The urging portion 8, which is a long rectangular plate member formed of a metallic material, is provided on an upper surface of the second head supporting member 10 that is opposite to the head supporting portion 5 of the first head supporting member 7 with a predetermined gap interposed therebetween. Holes 15 that can support elastic members 14, which will be described later, are formed in the urging portion 8 at positions that are equidistant from a virtual center line of the urging portion 8 in the longitudinal direction. A pair of second arms 9 formed of a metal plate are attached to both ends of the urging portion 8 in the longitudinal direction so as to extend backward.

The second arms 9 have crosspiece portions 9a that are formed by cutting and bending leading ends inward so as to be opposite to each other, and both ends of the urging portion 8 in the longitudinal direction are connected to the crosspiece portions 9a by screws. In addition, a flat stopper 9b is formed in an outer circumferential portion of each of the second arm 9 above the crosspiece portion 9a, and the anchoring portions 6b of the first arms 6 comes into contact with the stoppers 9b. Further, second support holes 9c are formed at the rear ends of the second arms 9.

Elastic members 16 formed of, for example, compressed coil springs are supported by the two holes 15 formed in the urging portion 8, and the elastic members 16 are elastically urged in a direction in which the head supporting portion 5 and the urging portion 8 are separated from each other to elastically urge the head supporting portion 5 to the platen roller 2.

At that time, the stoppers 9b of the second head supporting member 10 come into contact with the anchoring portions 6b of the first head supporting member 7.

In the head supporting member 4, the first and second support holes 6a and 9c, serving as rotatable supporting portions, are supported by support shafts (not shown) that are formed on the frame. Therefore, a head up/down mechanism (not shown) is driven to rotate the leading end of the head supporting member 4 for supporting the thermal head 3 on the two support holes 6a and 9c, serving as rotating axes, to bring the thermal head 3 into contact with the platen roller 22 or to separate the thermal head 3 from the platen roller 22.

As described above, in the thermal printer 1 according to the related art, the thermal head 3 is mounted to the head supporting portion 5 of the head supporting member 4 with the head holder 12 interposed therebetween (see a side view of FIG. 6 that schematically illustrates main components of the thermal head).

In order to meet current demands for a reduction in the thickness of a thermal head of a thermal printer, it is considered to directly fix the thermal head 3 to the head supporting portion 5 without the head holder 12 interposed therebetween.

However, generally, the head substrate 3a is formed of ceramic, and the head supporting portion 5 of the head supporting member 4 is formed of aluminum from the viewpoint of manufacturing costs (the reason why aluminum is suitable for a material forming the head supporting portion will be described later with reference to exemplary embodiments of the invention). In this case, ceramic and aluminum have different thermal expansion coefficients.

For this reason, when the heating elements 3b are turned on and the thermal head 3 is heated at a temperature of about 300° C., the head supporting portion 5 formed of aluminum is deformed due to thermal stress, and the amount of curvature of the thermal head 3 (hereinafter, simply referred to as ‘the amount of curvature’) increases, which makes it difficult to obtain a good recording result.

It is preferable to select a material forming the head supporting portion 5 for supporting the thermal head 3 that is heated at a high temperature when power is turned on, in consideration of physical properties, particularly, a thermal expansion coefficient and thermal diffusivity. As the thermal expansion coefficient increases, the amount of curvature of the thermal head 3 increases. In this case, during printing, it is difficult to obtain good contact between the thermal head 3 and a recording medium, which results in a bad recording result. If the thermal diffusivity is lowered, heat is stored in the heating elements 3b when power is turned on. In this case, ink that remains on the ink ribbon is transferred to the recording medium, which makes it difficult to take off the ink ribbon from the recording medium, or unnecessary ink drops to the recording medium. As a result, it is difficult to obtain a good recording result.

In order to solve the problem of the thermal head being curved, it is considered to provide a mechanism for adjusting the amount of curvature of the thermal head as in the thermal printer according to the related art. However, in the related art, the mechanism for adjusting the amount of curvature of the thermal head is provided in order to stabilize the traveling of the ink ribbon, not to reduce the thermal stress, unlike embodiments of the invention. Therefore, in this case, it is difficult to adjust the amount of curvature of the thermal head in consideration of the thermal stress, and the structure of the thermal printer becomes complicated. As a result, it is difficult to reduce the thickness of the peripheral structure of the thermal head.

### SUMMARY

According to an aspect of the invention, a thermal printer includes: a thermal head that has heating elements arranged on a head substrate in a longitudinal direction thereof. Ahead supporting member has a head supporting portion, which is a rectangular plate, for supporting the thermal head at a leading end, and pivots on a rotating axis that is provided at a rear end to contact or separate the thermal head with or from a platen. A plurality of rectangular opening portions are provided in a surface of the head supporting portion in the longitudinal direction so as to extend in a direction orthogonal to the longitudinal direction. In this structure, the thermal head is directly fixed to the head supporting portion.

According to the above-mentioned structure, the opening portions can absorb thermal stress causing the head supporting portion to expand in the longitudinal direction during heating. Therefore, even when materials forming the thermal head and the head supporting portion for supporting the thermal head have different thermal expansion coefficients, it is possible to keep the amount of curvature of the thermal head constant, without providing a complicated mechanism for adjusting the amount of curvature.

Further, according to the above-mentioned structure, it is possible to directly fix the thermal head to the head supporting portion without the head holder interposed therebetween, unlike the related art. Therefore, it is possible to reduce the thickness of the peripheral structure of the thermal head and reduce the number of parts (specifically, the removal of the head holder), thereby lowering manufacturing costs.

### BRIEF DESCRIPTION OF THE DRAWINGS

FIG. 1 is a side view schematically illustrating a head supporting member of a thermal printer according to a first embodiment of the disclosure;

FIG. 2 is a plan view schematically illustrating a head supporting portion of the head supporting member shown in FIG. 1;

FIG. 3 is a side view schematically illustrating main components of a thermal head of a thermal printer according to a second embodiment of the disclosure;

FIG. 4 is a plan view schematically illustrating a head supporting portion of a head supporting member shown in FIG. 3;

FIG. 5 is a perspective view illustrating a printing unit of a thermal printer according to the related art; and

FIG. 6 is a side view schematically illustrating main components of a thermal head of the thermal printer according to the related art.

### DESCRIPTION OF THE EMBODIMENTS

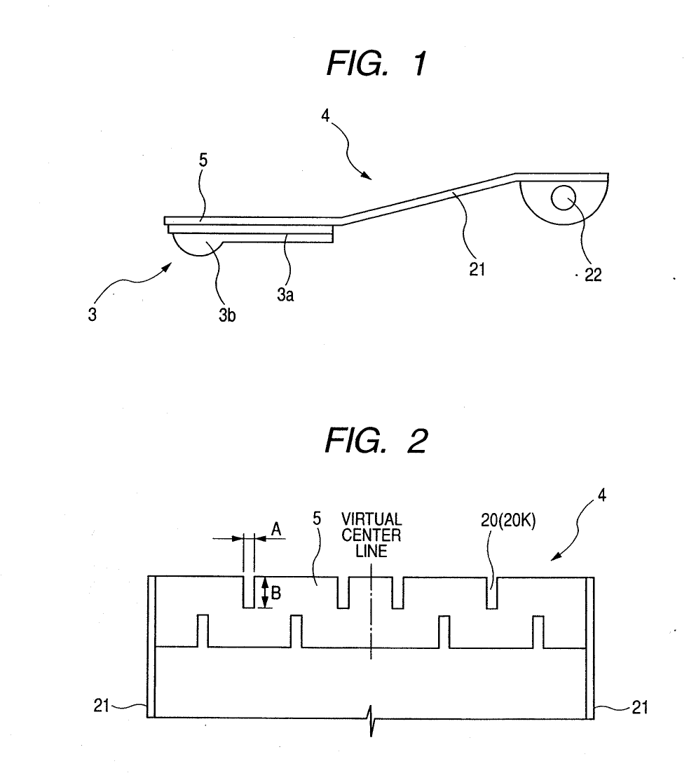

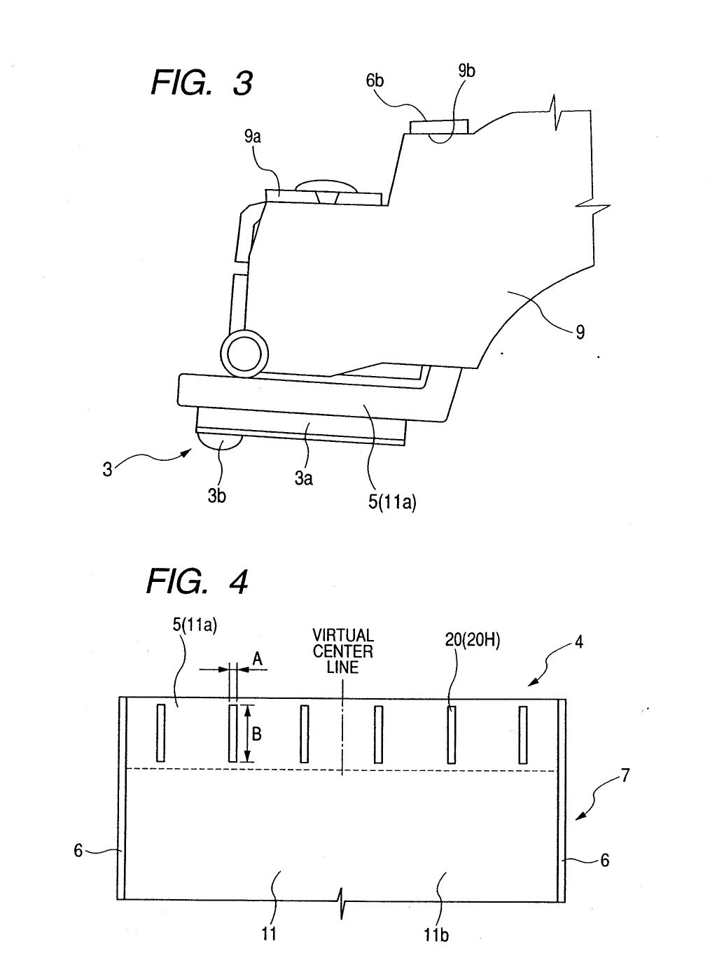

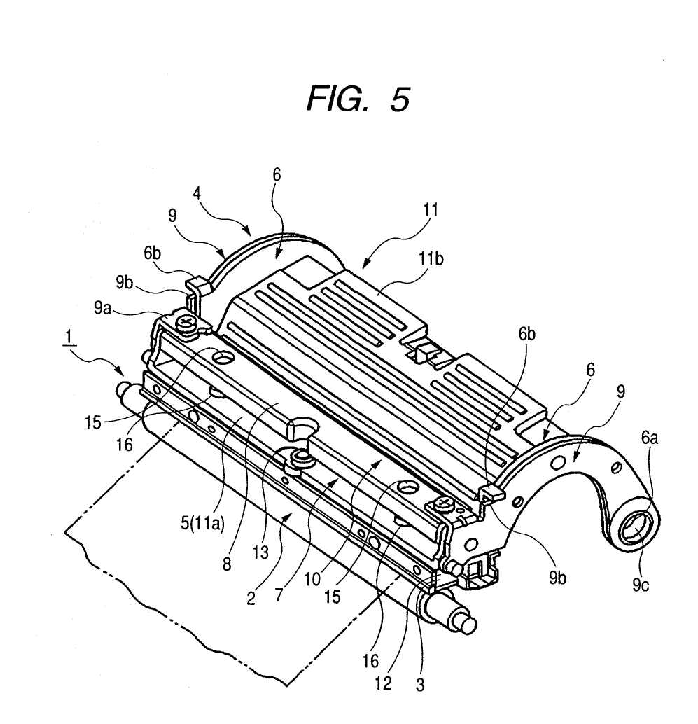

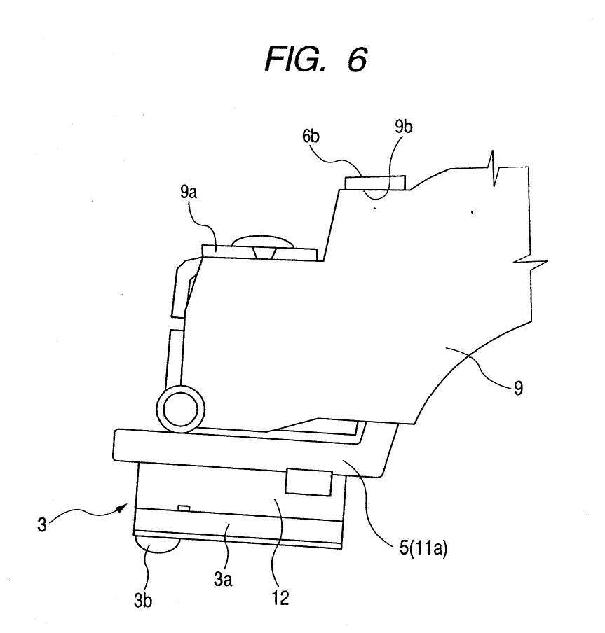

Hereinafter, the peripheral structure of a thermal head, which is a main component of a thermal printer according to an embodiment of the invention, will be described with reference to FIGS. 1 to 4, and then another embodiment of the disclosure; will be described later. FIG. 1 is a side view schematically illustrating a head supporting member of a thermal printer according to a first embodiment of the disclosure. FIG. 2 is a plan view schematically illustrating a head supporting portion of the head supporting member shown in FIG. 1. FIG. 3 is a side view schematically illustrating a main part of a head supporting member of a thermal printer according to a second embodiment of the disclosure. FIG. 4 is a plan view schematically illustrating a head supporting portion of the head supporting member shown in FIG. 3. In a thermal printer 1 according to the first and second embodiments of the disclosure, the same components as those in a thermal printer according to the related art are denoted by the same reference numerals.

First, the peripheral structure of a thermal head of the thermal printer 1 according to the embodiment of the disclosure will be described below.

In the thermal printer 1 according to this embodiment of the disclosure, a head substrate 3a of a thermal head 3 is directly attached to a head supporting portion 5 of a head supporting member 4 that is formed of aluminum by, for example, a fixing member, such as screws or an adhesive (not shown), without a head holder 12 interposed therebetween.

The head supporting portion 5 of the head supporting member 4 is a long rectangular plate member that has substantially the same shape as the bottom of the head substrate 3a of the thermal head 3, serving as an adhesive surface. A plurality of rectangular opening portions 20, which extend in a direction orthogonal the longitudinal direction of the head supporting portion 5, are formed in the head supporting portion 5 in the longitudinal direction.

It is preferable that six or more opening portions 20 be provided at both sides of a virtual center line of the head supporting portion 5 in the longitudinal direction so as to be symmetric with respect to the virtual center line. In addition, preferably, the length (which is represented by A in FIG. 2) of the opening portion 20 in the longitudinal direction of the head supporting portion 5 is equal to or larger than the thickness of a rectangular plate member forming the head supporting portion 5. Preferably, the total length of these opening portions 20 in the longitudinal direction of the head supporting portion 5 is equal to or larger than 10% of the length of the head supporting portion 5 in the longitudinal direction. Preferably, the length (which is represented by B in FIG. 2) of the opening portion 20 in a direction orthogonal to the longitudinal direction of the head supporting portion 5 is in the range of 40% to 80% of the length of the head supporting portion 5 in the direction orthogonal to the longitudinal direction.

The opening portion 20 may be a cut-out portion 20K that is formed at the edge of the head supporting portion 5, which is a rectangular plate member, or a window portion 20H that is formed in the surface of the head supporting portion 5.

FIGS. 1 and 2 show the head supporting member 4 for supporting the 4-inch (about 10 mm) thermal head 3 provided in the thermal printer having the above-mentioned characteristics according to the first embodiment of the invention.

The size of the head supporting portion 5 is larger than that of the thermal head 3, and is formed of an aluminum plate having a length of 120 mm, a width of 20 mm, and a thickness of 2 mm. Eight opening portions 20 are provided at both sides of a virtual center line of the head supporting portion 5 in the longitudinal direction so as to be symmetric with respect to the virtual center line. Specifically, eight cut-out portions 20K are formed in a zigzag at both sides of the head supporting portion 5 that extend in the longitudinal direction.

Preferably, the length (which is represented by A in FIG. 2) of the cut-out portion 20K in the longitudinal direction of the head supporting portion 5 is equal to or larger than the thickness of a rectangular plate member forming the head supporting portion 5. In this embodiment, the length of the cut-out portion 20K in the longitudinal direction of the head supporting portion 5 is set to 3 mm. The total length of the cut-out portions 20K in the longitudinal direction of the head supporting portion 5 is set to 20% of the length of the head supporting portion 5 in the longitudinal direction, which is 120 mm.

The length (which is represented by B in FIG. 2) of the cut-out portion 20K in a direction (hereinafter, referred to as a ‘width direction’) orthogonal to the longitudinal direction of the head supporting portion 5 is set to 8 mm which is 40% of the width of the head supporting portion 5, 20 mm.

As such, the cut-out portions 20K, which serve as the opening portions 20, are provided at both sides of the virtual center line of the head supporting portion 5 in the longitudinal direction so as to be symmetric with respect to the virtual line. In this way, the cut-out portions 20K can absorb the expansion of the head supporting portion 5 that is formed of aluminum, due to thermal stress generated in the longitudinal direction of the head supporting portion 5. Thus, it is possible to reduce the amount of curvature of the thermal head 3. In addition, it is possible to form the head supporting portion 5 having linear symmetry with respect to the center line thereof.

The opening portions 20 may be formed in the surface of the head supporting portion 5 as the window portions 20H, or they may be formed in the head supporting portion 5 together with the window portions 20H.

Leading ends of a pair of arms 21 that are formed of aluminum are connected to both ends of the head supporting portion 5 in the longitudinal direction to form the head supporting member 4.

Support holes 22, which serve as rotatable supporting portions, are formed at the rear ends of the pair of arms 21. The arms 21 pivot on the support holes 22 such that a pressure contact mechanism (not shown) brings heating elements 3b formed on the head substrate 3a of the thermal head 3 into pressure contact with a platen, with an ink ribbon and a recording medium interposed therebetween. Then, the heating elements 3b are selectively driven to generate heat on the basis of recording information, so that information is recorded on the recording medium.

The head supporting member 4 also serves as a heat dissipating member.

In the thermal printer 1 having the above-mentioned structure according to this embodiment, the cut-out portions 20K can absorb thermal stress causing the head supporting portion 5 to expand in the longitudinal direction during heating. Therefore, even when materials forming the thermal head 3 and the head supporting portion 5 for supporting the thermal head 3 have different thermal expansion coefficients, it is possible to keep the amount of curvature of the thermal head 3 constant. As a result, it is possible to maintain good contact between the thermal head 3 and a recording medium at all times during printing, and thus obtain a desired recording result.

Further, in this embodiment, the thermal head 3 is directly fixed to the head supporting portion 5 without the head holder 12 interposed therebetween, which makes it possible to reduce the thicknesses of the peripheral structure of the thermal head.

FIGS. 3 and 4 are diagrams illustrating a thermal printer 1 according to the second embodiment of the invention. Specifically, FIGS. 3 and 4 show the structure of main components of a thermal head of the thermal printer 1 according to the invention that corresponds to the thermal printer 1 according to the related art.

The structure of the thermal printer according to this embodiment is similar to that of the thermal printer according to the related art except that an adjusting screw 13 for adjusting the amount of curvature of the thermal head 3 is provided to the first head supporting member 4. Therefore, in this embodiment, only the peripheral structure of the thermal head will be described below, but a description of the other structures will be omitted.

The thermal head 3 has a plurality of heating elements 3b (not shown) that are arranged on a head substrate 3a formed of ceramic in the longitudinal direction thereof. The thermal head 3 is supported by a leading end of the head supporting member 4 such that the heating elements 3b can contact with or be separated from a platen roller 2 that is supported by a side surface of a frame.

A first head supporting member 7 and a second head supporting member 10 form the head supporting member 4, and the first head supporting member 7 is formed of a material having a good heat dissipating property, such as aluminum. A head supporting portion 5, which is a rectangular plate member for supporting the thermal head 3, is formed at leading ends of a pair of first arms 6 forming the first head supporting member 7. Thus, the head supporting portion 5 is integrated with the first arms 6. In this embodiment, the head substrate 3a of the thermal head 3 is directly attached to the head supporting portion 5 by a fixing member (not shown), such as screws or an adhesive, without the head holder 12 interposed therebetween.

In this embodiment, the head supporting member 4 for supporting the 4-inch (about 10 mm) thermal head 3 is provided. The size of the head supporting portion 5 is larger than that of the thermal head 3, and is formed of an aluminum plate having a length of 120 mm, a width of 20 mm, and a thickness of 2 mm. Six window portions 20H are provided at both sides of a virtual center line of the head supporting portion 5 in the longitudinal direction as opening portions 20 so as to be symmetric with respect to the virtual center line.

In this embodiment, the length (which is represented by A in FIG. 4) of the window portion 20H in the longitudinal direction of the head supporting portion 5 is set to 2 mm. The total length of the window portions 20H in the longitudinal direction of the head supporting portion 5 is set to 10% of the length of the head supporting portion 5 in the longitudinal direction, which is 120 mm.

The length (which is represented by B in FIG. 4) of the window portion 20K in the width direction of the head supporting portion 5 is set to 16 mm which is 80% of the width of the head supporting portion 5, 20 mm.

As such, the window portions 20H, serving as the opening portions 20, are formed at both sides of the virtual center line of the head supporting portion 5 in the longitudinal direction so as to be symmetric with respect to the virtual center line. In this way, the window portions 20H can absorb the expansion of the head supporting portion 5 that is formed of aluminum, due to thermal stress generated in the longitudinal direction of the head supporting portion 5. Thus, it is possible to reduce the amount of curvature of the thermal head 3. In addition, it is possible to form the head supporting portion 5 having linear symmetry with respect to the center line thereof.

Furthermore, in this embodiment, the head supporting portion 5 also serves as a heat dissipating plate 11a of the heat dissipating member 11, and the rear end of the head supporting portion 5 is connected to a planar heat dissipating portion 11b that extends backward, thereby forming the heat dissipating member 11. Therefore, it is possible to dissipate heat generated from the thermal head 3 during printing from the heat dissipating portion 11b through the head supporting portion 5 that also serves as the heat dissipating plate 11a.

In this embodiment, instead of the window portions 20H, cut-out portions 20K may be formed at the edge of the head supporting portion 5, which is a rectangular plate member, as the opening portions 20.

According to the above-mentioned structure, the heat dissipating portion can appropriately dissipate heat generated from the thermal head 3, and the window portions, serving as the opening portions 20 can absorb the expansion of the head supporting portion 5 due to thermal stress. Therefore, it is possible to reduce the amount of curvature of the thermal head 3 and thus keep the amount of curvature of the thermal head 3 constant. In addition, it is possible to pivot the head supporting member 4 on the rotatable supporting portion, which is a rotating axis, to appropriately bring the thermal head 3 into contact with the platen roller 2.

Therefore, it is possible to maintain good contact between the thermal head 3 and a recording medium at all times during printing, and thus obtain a desired recording result.

The invention is not limited to the above-described embodiments, but various modifications and changes of the invention can be made without departing from the scope and spirit of the invention. For example, a material forming the head supporting portion is not limited to aluminum. Aluminum is most suitable for a material forming the head supporting portion from the viewpoint of physical properties, such as costs, a thermal expansion coefficient, thermal diffusivity, and thermal conductivity. However, a material having a thermal expansion coefficient of 10 to 25 and a thermal conductivity of 40 to 250, such as a galvanized steel sheet or SUS304, may be used as the material forming the head supporting portion. In this case, the arrangement and number of opening portions may be changed in consideration of the properties of the material.

1. A thermal printer comprising:
a thermal head that has heating elements arranged on a head substrate in a longitudinal direction thereof;
a head supporting member that has a head supporting portion, which is a rectangular plate, that supports the thermal head at a leading end, and pivots on a rotating axis that is provided at a rear end to contact or separate the thermal head with or from a platen; and
a plurality of rectangular opening portions that are provided in a surface of the head supporting portion in the longitudinal direction so as to extend in a direction orthogonal to the longitudinal direction,
wherein the thermal head is directly fixed to the head supporting portion.

2. The thermal printer according to claim 1,
wherein the length of the opening portion in the longitudinal direction of the head supporting portion is equal to or larger than the thickness of a rectangular planar member forming the head supporting portion.

3. The thermal printer according to claim 1,
wherein the opening portions are provided at both sides of a virtual center line of the head supporting portion in the longitudinal direction so as to be symmetric with respect to the virtual line.

4. The thermal printer according to claim 1,
wherein the number of opening portions is equal to or larger than 6,
the total length of the opening portions in the longitudinal direction of the head supporting portion is 10% or more of the length of the head supporting portion in the longitudinal direction, and
the length of the opening portion in the direction orthogonal to the longitudinal direction of the head supporting portion is in the range of about 40% to about 80% of the length of the head supporting portion in the direction orthogonal to the longitudinal direction.

5. The thermal printer according to claim 1,
wherein the opening portions are cut-out portions that are formed at the edge of the head supporting portion, which is the rectangular plate, or window portions that are formed in the surface of the thermal head supporting portion.

6. The thermal printer according to claim 1,
wherein the head supporting member includes a pair of arms that are connected to both ends of the head supporting portion in the longitudinal direction,
the arms support the head supporting portion at their leading ends, and
each of the arms has a rotatable supporting portion, serving as a rotating axis, at a rear end.

7. The thermal printer according to claim 1,
wherein the head supporting member includes a heat dissipating member having a heat dissipating portion that is continuously connected to the rear end of the head supporting portion and dissipates heat generated from the thermal head.
